(19) United States
(12) Patent Application Publication
(10) Pub. No.: US 2026/0058574 A1
(43) Pub. Date: Feb. 26, 2026

(54) PIEZOELECTRIC ACTUATOR

(71) Applicant: Luxshare Intelligent Manufacture Technology (Changshu) Co., Ltd, Changshu City (CN)

(72) Inventors: Po-Ying TSENG, Changshu City (CN); Chen-Yu CHAO, Changshu City (CN); Sz-Rung LAI, Changshu City (CN)

(73) Assignee: Luxshare Intelligent Manufacture Technology (Changshu) Co., Ltd, Changshu City (CN)

(21) Appl. No.: 18/955,457

(22) Filed: Nov. 21, 2024

(30) Foreign Application Priority Data
Aug. 23, 2024 (CN) 202411162497.7

(51) Int. Cl. H02N 2/10; G02B 7/04

(52) U.S. Cl. CPC H02N 2/103; G02B 7/04

(57) ABSTRACT

A piezoelectric actuator includes a securing end, an actuation end, a piezoelectric assembly, a secondary driven member, a commutator and a rail. The piezoelectric assembly can drive the secondary driven member to move in the first direction relative to the securing end. The secondary driven member is provided with a first guide surface. The rail is provided with a second guide surface. The commutator includes a commutation shaft, a first commutation wheel and a second commutation wheel. The first commutation wheel and the second commutation wheel are coaxially sleeved on the commutation shaft. The actuation end is disposed on the commutation shaft. The first commutation wheel can roll along the first guide surface, and the second commutation wheel can roll along the second guide surface, so that the commutator is movable in the second direction. The second direction is set at an angle from the first direction.

### CROSS-REFERENCE TO RELATED APPLICATION(S)

This application claims priority to Chinese Patent Application No. 202411162497.7 filed Aug. 23, 2024, the disclosure of which is incorporated herein by reference in its entirety.

### TECHNICAL FIELD

The present invention relates to the field of micro-drive technology and, in particular, to a piezoelectric actuator.

### BACKGROUND

As an element that uses a reverse piezoelectric effect to generate a displacement by applying a voltage, a piezoelectric actuator may provide an alternative for familiar electromagnetic devices (such as a motor and a solenoid). The piezoelectric actuator has the advantages of higher reliability, lower power consumption, smaller size and higher position resolution.

In the related art, in the piezoelectric actuator, a piezoelectric assembly is usually designed at a securing end and contacts a movable portion, a piezoelectric material is deformed through voltage conversion, and the movable portion is pushed to move in a particular direction through the friction surface of the movable portion. However, to ensure that the friction surface always contacts the piezoelectric assembly during the movement of the movable portion, the size of the movable portion is required to be greater than or equal to the size of the piezoelectric assembly in the movement direction plus two times the required stroke. Moreover, a space of at least one time the stroke is required to be reserved in front and back of the movable portion for the movable portion to use. Therefore, it is difficult for the piezoelectric actuator to reduce the size in design and achieve a large stroke in a limited space, resulting in fewer application scenarios for the piezoelectric actuator.

### SUMMARY

The present invention provides a piezoelectric actuator that has a smaller size and more application scenarios.

A piezoelectric actuator is provided.

The piezoelectric actuator includes a securing end, an actuation end and a piezoelectric assembly; and a secondary driven member, a commutator and a rail, where the piezoelectric assembly is configured to drive the secondary driven member to move in a first direction relative to the securing end, the secondary driven member is provided with a first guide surface, the rail is provided with a second guide surface, the commutator includes a commutation shaft , a first commutation wheel and a second commutation wheel, where the first commutation wheel and the second commutation wheel are coaxially sleeved on the commutation shaft, and the actuation end is disposed on the commutation shaft; the first commutation wheel is configured to roll along the first guide surface, and the second commutation wheel is configured to roll along the second guide surface, so that the commutator is movable in a second direction; and the second direction is set at an angle from the first direction. In the present invention, the arrangement of the secondary driven member and the commutator can enable the piezoelectric assembly to drive the secondary driven member to move in the first direction relative to the securing end. Moreover, the commutation of the commutator can enable the actuation end to move in the second direction relative to the securing end, that is, the displacement of the actuation end in the second direction can be converted to the displacement of the secondary driven member in the first direction so that the size of the secondary driven member in the second direction can be reduced, and a movable space is not necessarily reserved in the second direction, thereby effectively reducing the size of the piezoelectric actuator and adding the application scenarios of the piezoelectric actuator. Optionally, the piezoelectric actuator is further provided with the rail. The rail is provided with the second guide surface. The secondary driven member is provided with the first guide surface. The actuation end is disposed on the commutation shaft of the commutator. The first commutation wheel and the second commutation wheel are coaxially sleeved on the commutation shaft. The first commutation wheel is configured to fit with the first guide surface, and the second commutation wheel is configured to fit with the second guide surface. When the secondary driven member moves relative to the securing end, the first guide surface drives the first commutation wheel to roll, and since the second guide surface extends in the second direction, the second commutation wheel moves on the rail in the second direction, thereby driving the actuation end to move in the second direction relative to the securing end. That is, the first commutation wheel and the second commutation wheel that are coaxially disposed fit with the first guide surface and the second guide surface respectively so that the actuation end and the secondary driven member can move in different directions.

### BRIEF DESCRIPTION OF DRAWINGS

To illustrate the technical solutions in embodiments of the present invention more clearly, the drawings used in the description of the embodiments of the present invention are briefly described below. Apparently, the drawings described below illustrate some of the embodiments of the present invention, and those of ordinary skill in the art may also obtain other drawings based on the content of the embodiments of the present invention and the drawings on the premise that no creative work is done.

FIG. 1 is a view of a piezoelectric actuator according to an embodiment of the present invention.

FIG. 2 is a partial view of an implementation of a piezoelectric actuator according to an embodiment of the present invention.

FIG. 3 is a partial view of another implementation of a piezoelectric actuator according to an embodiment of the present invention.

FIG. 4 is a view of multiple piezoelectric actuators applied to a camera lens according to an embodiment of the present invention.

FIG. 5 is a view of multiple piezoelectric actuators applied to a display module according to an embodiment of the present invention.

FIG. 6 is a view of multiple piezoelectric actuators applied to a lens according to an embodiment of the present invention.

FIG. 7 is a view of a piezoelectric actuator whose secondary driven member is hidden according to an embodiment of the present invention.

FIG. 8 is a view of a piezoelectric actuator whose securing end and decompression magnet are hidden according to an embodiment of the present invention.

FIG. 9 is another view of a piezoelectric actuator whose secondary driven member is hidden according to an embodiment of the present invention.

FIG. 10 is another view of a piezoelectric actuator whose securing end and decompression magnet are hidden according to an embodiment of the present invention.

FIG. 11 is yet another view of a piezoelectric actuator whose securing end is hidden according to an embodiment of the present invention.

FIG. 12 is still another view of a piezoelectric actuator according to an embodiment of the present invention.

FIG. 13 is a partial view of a piezoelectric actuator using a slidable commutator according to an embodiment of the present invention.

### REFERENCE LIST

100 securing end
110 fitting block
120 guide rod
200 actuation end
300 piezoelectric assembly
400 secondary driven member
410 first guide surface
411 first avoidance groove
420 first guide groove
430 second guide groove
440 installation groove
450 stop block
500 precompression magnet
600 decompression assembly
610 decompression magnet
620 decompression coil
700 commutator
710 first commutation wheel
720 second commutation wheel
730 commutation shaft
740 commutation block
800 rail
810 second guide surface
811 third guide groove
812 second avoidance groove
820 first avoidance notch
830 guide protrusion
840 second avoidance notch
910 optical lens module or display module
920 camera lens
930 lens
940 installation lug

### DETAILED DESCRIPTION

Embodiments of the present invention are described in detail hereinafter. Examples of the embodiments are illustrated in the drawings, where the same or similar reference numerals indicate the same or similar elements or elements having the same or similar functions. The embodiments described hereinafter with reference to the drawings are exemplary. The embodiments are intended to explain the present invention and are not to be construed as limiting the present invention.

In the description of the present invention, it is to be noted that orientations or position relations indicated by terms such as “center”, “upper”, “lower”, “left”, “right”, “vertical”, “horizontal”, “in” and “out” are based on the drawings. These orientations or position relations are intended to facilitate and simplify the description of the present invention and not to indicate or imply that a device or element referred to must have such particular orientations or must be configured or operated in such particular orientations. Thus, these orientations or position relations are not to be construed as limiting the present invention. In addition, terms such as “first” and “second” are used for the purpose of description and are not to be construed as indicating or implying relative importance. Terms “first position” and “second position” are two different positions.

Unless otherwise expressly specified and limited, the terms “installed”, “connected to each other”, “connected”, or “secured” are to be construed in a broad sense, for example, as securely connected or detachably connected; mechanically connected or electrically connected; directly connected to each other, indirectly connected to each other via an intermediary, or internally connected between two elements or interactional relationships between two elements. For those of ordinary skill in the art, specific meanings of the preceding terms in the present invention may be understood based on specific situations.

In the present invention, unless otherwise expressly specified and limited, when a first feature is described as being “above” or “below” a second feature, the first feature and the second feature may be in direct contact or be in contact via another feature between the two features. Moreover, when the first feature is described as being “on”, “above” or “over” the second feature, the first feature is right on, above or over the second feature, the first feature is obliquely on, above or over the second feature, or the first feature is simply at a higher level than the second feature. When the first feature is described as being “under”, “below” or “underneath” the second feature, the first feature is right under, below or underneath the second feature, the first feature is obliquely under, below or underneath the second feature, or the first feature is simply at a lower level than the second feature.

Technical solutions of the present invention are further described hereinafter in conjunction with the drawings and the embodiments.

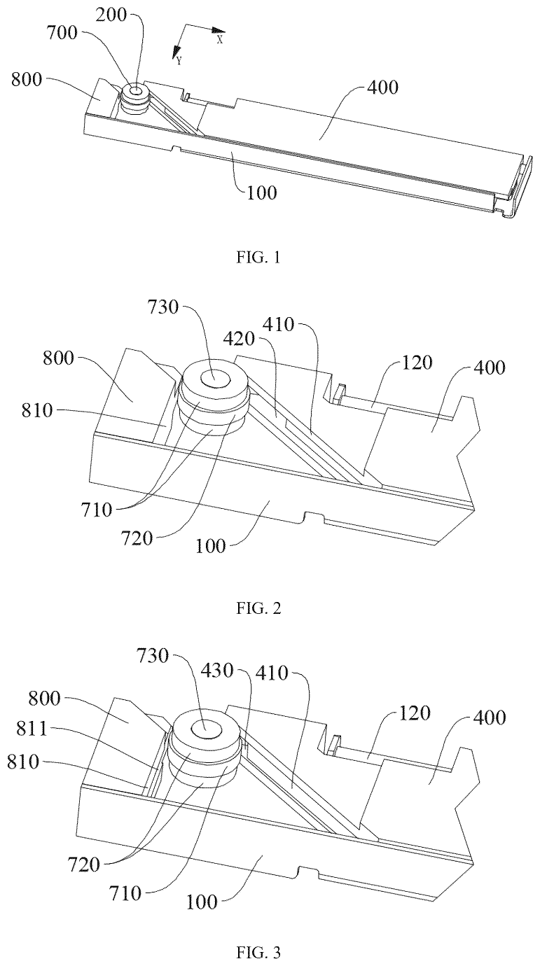

As shown in FIGS. 1 and 2, this embodiment provides a piezoelectric actuator. The piezoelectric actuator includes a securing end 100, an actuation end 200, a piezoelectric assembly 300, a secondary driven member 400, a commutator 700 and a rail 800. The piezoelectric assembly 300 can drive the secondary driven member 400 to move in the first direction relative to the securing end 100. The secondary driven member 400 is provided with a first guide surface 410. The rail 800 is provided with a second guide surface 810. The commutator 700 includes a commutation shaft 730, a first commutation wheel 710 and a second commutation wheel 720. The first commutation wheel 710 and the second commutation wheel 720 are coaxially sleeved on the commutation shaft 730. The actuation end 200 is disposed on the commutation shaft 730. The first commutation wheel 710 can roll along the first guide surface 410, and the second commutation wheel 720 can roll along the second guide surface 810, so that the commutator 700 is movable in the second direction. The second direction is set at an angle from the first direction.

The arrangement of the secondary driven member 400 and the commutator 700 can enable the piezoelectric assembly 300 to drive the secondary driven member 400 to move in the first direction relative to the securing end 100. Moreover, the commutation of the commutator 700 can enable the actuation end 200 to move in the second direction relative to the securing end 100, that is, the displacement of the actuation end 200 in the second direction can be converted to the displacement of the secondary driven member 400 in the first direction so that the size of the secondary driven member 400 in the second direction can be reduced, and a movable space is not necessarily reserved in the second direction, thereby effectively reducing the size of the piezoelectric actuator and adding the application scenarios of the piezoelectric actuator. Optionally, the piezoelectric actuator is further provided with the rail 800. The rail 800 is provided with the second guide surface 810. The secondary driven member 400 is provided with the first guide surface 410. The actuation end 200 is disposed on the commutation shaft 730 of the commutator 700. The first commutation wheel 710 and the second commutation wheel 720 are coaxially sleeved on the commutation shaft 730. The first commutation wheel 710 is configured to fit with the first guide surface 410, and the second commutation wheel 720 is configured to fit with the second guide surface 810. When the secondary driven member 400 moves relative to the securing end 100, the first guide surface 410 drives the first commutation wheel 710 to roll, and since the second guide surface 810 extends in the second direction, the second commutation wheel 720 moves on the rail 800 in the second direction, thereby driving the actuation end 200 to move in the second direction relative to the securing end 100. That is, the first commutation wheel 710 and the second commutation wheel 720 that are coaxially disposed fit with the first guide surface 410 and the second guide surface 810 respectively so that the actuation end 200 and the secondary driven member 400 can move in different directions.

In this embodiment, the first direction is an X direction shown in FIG. 1, the second direction is a Y direction shown in FIG. 1, and the X direction is vertical to the Y direction.

Further, one end of the secondary driven member 400 facing the commutator 700 is formed with a first guide groove 420, and groove tops of the first guide groove 420 form the first guide surface 410; when the secondary driven member 400 moves, the first commutation wheel 710 fits with the groove tops of the first guide groove 420; and since the diameter of the first commutation wheel 710 is less than the diameter of the second commutation wheel 720, and the groove depth of the first guide groove 420 is greater than the difference between a radius of the first commutation wheel 710 and a radius of the second commutation wheel 720, the second commutation wheel 720 is spaced from the groove bottom of the first guide groove 420. In this manner, no interference is present between the second commutation wheel 720 and the first guide groove 420 so that the fitting between the second commutation wheel 720 and the second guide surface 810 of the rail 800 cannot be affected.

Optionally, two first commutation wheels 710 are provided, and the second commutation wheel 720 is disposed between the two first commutation wheels 710. The two first commutation wheels 710 are in rolling fit with the groove tops on two sides of the first guide groove 420 respectively. The second commutation wheel 720 is disposed within the first guide groove 420 and is spaced from the groove bottom of the first guide groove 420. The arrangement of the two first commutation wheels 710 enables a more uniform force applied to the commutator 700 so that the fitting between the commutator 700 and the secondary driven member 400 can be more stable. Moreover, the arrangement of the first guide groove 420 can also effectively prevent the second commutation wheel 720 from escaping from the first guide groove 420 so that the fitting between the commutator 700 and the secondary driven member 400 can be more reliable.

In this embodiment, the first commutation wheel 710 and the second commutation wheel 720 may be sleeved on the commutation shaft 730 through a bearing, or an outer ring of a bearing is used as a first commutation wheel 710 or a second commutation wheel 720. In other embodiments, the axial length of the first commutation wheel 710 may also be greater than the axial length of the second commutation wheel 720, and the second commutation wheel 720 is rotatably disposed on the outer side of the first commutation wheel 710 so that the first commutation wheel 710 can be in rolling fit with the first guide surface 410, and the second commutation wheel 720 can be in rolling fit with the second guide surface 810.

As an optional solution for the piezoelectric actuator, to enable the simultaneous fitting between the commutator 700 and the first guide surface 410 and the second guide surface 810, as shown in FIG. 3, one end of the secondary driven member 400 facing the commutator 700 is formed with a second guide groove 430, the diameter of the first commutation wheel 710 is greater than the diameter of the second commutation wheel 720, the groove bottom of the second guide groove 430 forms the first guide surface 410, and the groove depth of the second guide groove 430 is less than the difference between a radius of the first commutation wheel 710 and a radius of the second commutation wheel 720. With this arrangement, when the secondary driven member 400 moves, the first commutation wheel 710 fits with the groove bottom of the second guide groove 430, and since the groove depth of the second guide groove 430 is less than the difference between a radius of the first commutation wheel 710 and a radius of the second commutation wheel 720, the groove top of the second guide groove 430 does not interfere with the second commutation wheel 720 so that the rolling fit between the second commutation wheel 720 and the second guide surface 810 of the rail 800 cannot be affected.

Further, two second commutation wheels 720 are provided, and the first commutation wheel 710 is disposed between the two second commutation wheels 720. The two second commutation wheels 720 can improve the stability of the fitting between the commutator 700 and the rail 800.

Optionally, the second guide surface 810 is formed with a third guide groove 811 extending in the second direction, and the groove depth of the third guide groove 811 is greater than the difference between a radius of the first commutation wheel 710 and a radius of the second commutation wheel 720 to avoid interference between the groove bottom of the third guide groove 811 and the first commutation wheel 710 and ensure the rolling fit between the second commutation wheel 720 and the second guide surface 810.

Exemplarily, the first guide surface 410 is disposed at an included angle of 30° to 60° with the first direction. Optionally, the first guide surface 410 is disposed at an included angle of 45° with the first direction. In other embodiments, those skilled in the art may set the included angle between the first guide surface 410 and the first direction according to actual application scenarios, and no specific limitation is made here.

Optionally, as shown in FIG. 1, the securing end 100 is provided with a guide rod 120 extending in the first direction, and the secondary driven member 400 can slide along the guide rod 120. The arrangement of the guide rod 120 can limit the movement direction of the secondary driven member 400 relative to the securing end 100.

In this embodiment, to improve the reliability of the guide rod 120 in limiting the secondary driven member 400, the secondary driven member 400 is further formed with a guide groove extending in the first direction, and the guide rod 120 is disposed within the guide groove.

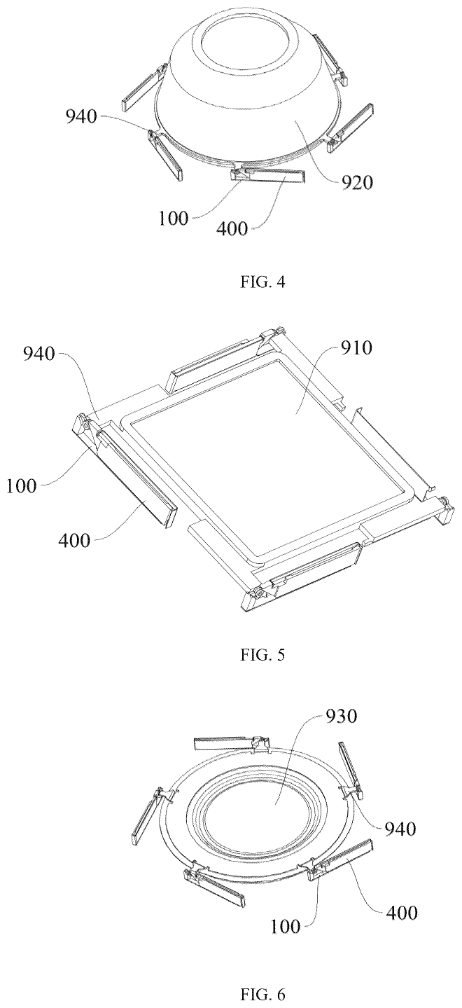

Optionally, as shown in FIGS. 4 to 6, the actuation end 200 is connected to an optical lens module or display module 910, that is, the piezoelectric actuator may be configured to actuate the optical lens module or display module 910 in the axial direction of the optical lens module or display module 910. Optionally, the optical lens module may be a camera lens 920 or a lens 930 so as to change the focal length.

Further, the optical lens module or display module 910 is provided with multiple installation lugs 940 in the circumferential direction of the optical lens module or display module 910, and actuation ends 200 of multiple piezoelectric actuators are in a one-to-one correspondence connected to the multiple installation lugs 940. The arrangement of the multiple piezoelectric actuators can enable the optical lens module or display module 910 to be driven more stably and reliably.

It is to be noted that the camera lens 920 is provided with six piezoelectric actuators that are evenly spaced apart and flexible in the circumferential direction of the camera lens 920. When two piezoelectric actuators are used as the rotation axis, the camera lens 920 may be rotated by driving the other four piezoelectric actuators to move. It is to be understood that during rotation, piezoelectric actuators located on two sides of the rotation axis move in opposite directions, that is, actuation ends 200 of two piezoelectric actuators located on one side of the rotation axis move upward while actuation ends 200 of two piezoelectric actuators located on the other side of the rotation axis move downward.

In other embodiments, the piezoelectric actuator further includes a precompression magnet 500 and a decompression assembly 600; the precompression magnet 500 is disposed on the secondary driven member 400, and a magnetic force is present between the precompression magnet 500 and the securing end 100 to enable the secondary driven member 400 to be pressed against the securing end 100 with a preset pressure; the decompression assembly 600 includes a decompression magnet 610 and a decompression coil 620, and the decompression coil 620 can be electrified to have a magnetic field with the same or opposite magnetic properties as the decompression magnet 610 so as to attract or repel the securing end 100 so that the securing end 100 can be still relative to the actuation end 200, or the securing end 100 can move relative to the actuation end 200; or the decompression coil 620 can change the direction of a current to have a magnetic field with the same or opposite magnetic properties as the decompression magnet 610.

The precompression magnet 500 is disposed on the secondary driven member 400, and the securing end 100 is configured as a magnetic material to magnetically attract the precompression magnet 500 to enable the secondary driven member 400 to be pressed against the securing end 100 with the preset pressure so that the upper limit of a holding force between a piezoelectric element and the friction surface can be increased when the piezoelectric assembly 300 is not electrified, thereby improving the design freedom of the piezoelectric actuator. Moreover, the secondary driven member 400 can move more stably. In addition, the piezoelectric actuator is further provided with the decompression assembly 600. The decompression assembly 600 can change the holding force or enable or disenable the brake between the actuation end 200 and the securing end 100 by changing the magnitude or direction of a magnetic force between the decompression coil 620 and the decompression magnet 610. Optionally, when the magnetic field of the decompression coil 620 is in the same direction as the decompression magnet 610, an attractive force is present between the decompression magnet 610 and the securing end 100, which may increase the upper limit of the preset pressure, and when the magnetic field of the decompression coil 620 is in the opposite direction to the decompression magnet 610, a repulsive force is present between the decompression magnet 610 and the securing end 100, that is, the brake is disenabled, and the actuation end 200 may move relative to the securing end 100 in this case.

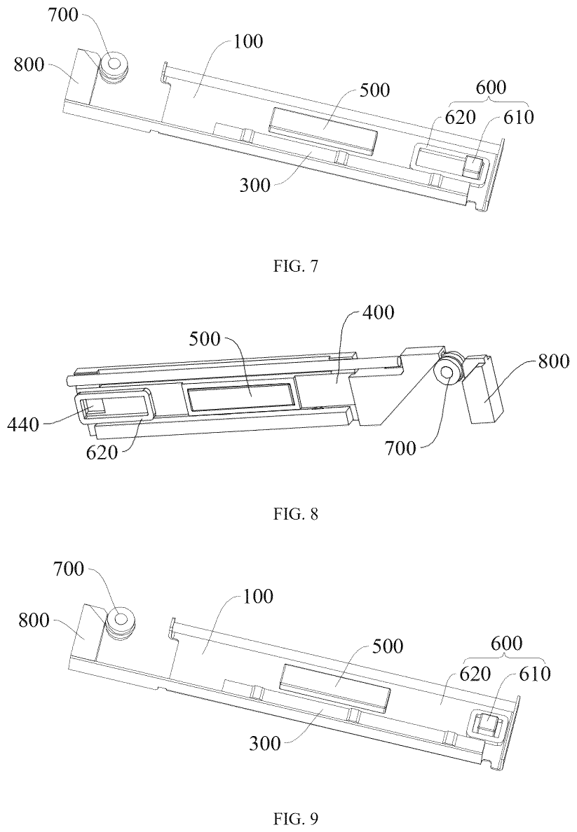

In this embodiment, as shown in FIGS. 7 to 12, to install the decompression assembly 600, the decompression magnet 610 is disposed on the secondary driven member 400 and can move in a direction facing the securing end 100 and in a direction facing away from the securing end 100 so that the decompression magnet 610 can approach and attract the securing end 100 when the decompression coil 620 is electrified and can repel and move away from the securing end 100 when the decompression coil 620 is not electrified.

Optionally, as shown in FIGS. 7 and 8, one side of the secondary driven member 400 facing the securing end 100 is formed with an installation groove 440, and the decompression magnet 610 is slidably disposed within the installation groove 440. It is to be understood that the shape of the installation groove 440 is adapted to the decompression magnet 610 to limit the movement of the decompression magnet 610 along the plane in which the secondary driven member 400 and the securing end 100 move relative to each other. Optionally, the decompression magnet 610 is a cylinder, a cube, or a cuboid. Correspondingly, the cross-section of the installation groove 440 is round, square, or rectangular. It is to be noted that the decompression coil 620 may be wound into different shapes, such as a square, rectangular, or track-shaped cross-section; for one aspect, the decompression coil 620 is configured to be adapted to the shape of the decompression magnet 610, and for another aspect, the decompression coil 620 may be provided according to a desired magnetic force. No specific limitation is made herein.

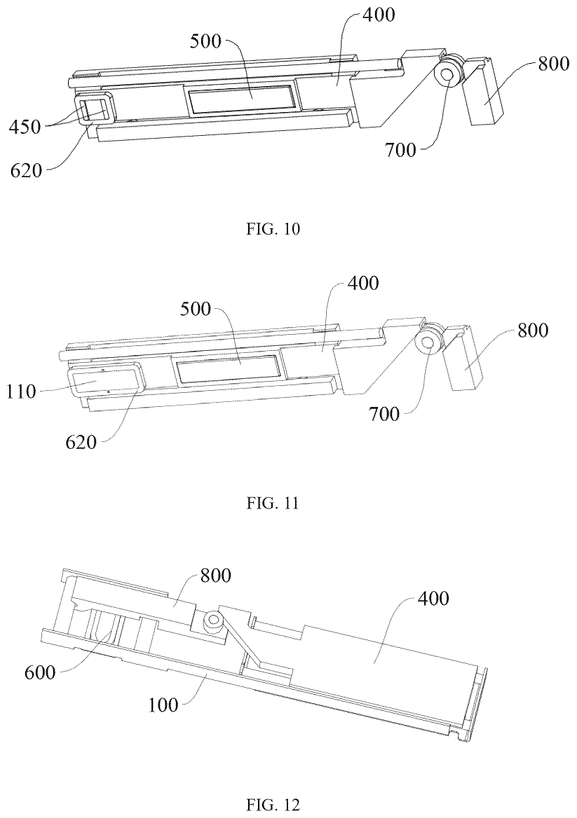

In other embodiments, to simplify the structure of the installation groove 440, as shown in FIGS. 9 and 10, the side of the secondary driven member 400 facing the securing end 100 is provided with two stop blocks 450 in the movement direction of the secondary driven member 400, where the two stop blocks 450 are spaced apart, the decompression magnet 610 is disposed within the two stop blocks 450, and the decompression coil 620 is wound around outer sides of the two stop blocks 450. The arrangement of the two stop blocks 450 can enable the decompression magnet 610 not to move with the secondary driven member 400 relative to the securing end 100 so that while the installation of the decompression magnet 610 is ensured, the decompression coil 620 can also be wound around the outer sides of the two stop blocks 450, further simplifying the structure of the piezoelectric actuator.

Optionally, as shown in FIG. 11, the securing end 100 may also be provided with a fitting block 110 which faces the decompression magnet 610 and can be attracted or repelled by the decompression magnet 610. The fitting block 110 is disposed to replace the fitting between the securing end 100 and the decompression magnet 610. For one aspect, the fitting block 110 may be convenient to replace separately after wear and tear, and for another aspect, the decompression coil 620 may also be wound around the fitting block 110 to simultaneously install the decompression coil 620.

Optionally, the precompression magnet 500 is an electromagnet with an adjustable magnetic force. The magnetic force of the electromagnet has a wider adjustment range, further increasing the upper limit of the holding force between the piezoelectric element and the friction surface when the piezoelectric assembly 300 is not electrified.

As an optional solution for the piezoelectric actuator, as shown in FIG. 12, the decompression magnet 610 is disposed at the actuation end 200 and can move in a direction facing the securing end 100 and in a direction facing away from the securing end 100, and the decompression coil 620 is disposed at the securing end 100. The decompression magnet 610 and the decompression coil 620 act on the actuation end 200 and drive the actuation end 200 to be secured relative to the securing end 100 so as to enable the brake of the piezoelectric actuator.

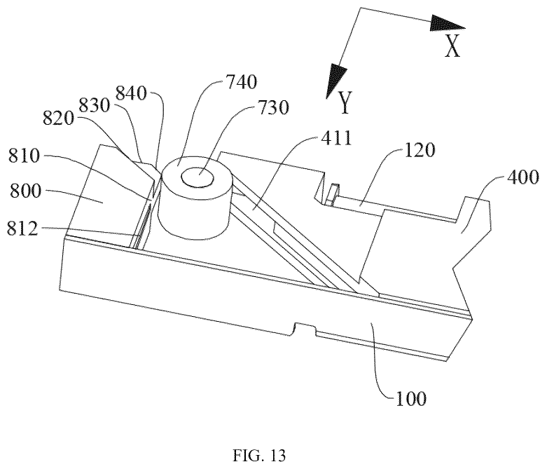

In other embodiments, as shown in FIG. 13, the arrangement of the first commutation wheel 710 and the second commutation wheel 720 that roll may also be eliminated, and the commutator 700 is instead configured to slide with the first guide surface 410 and the second guide surface 810. That is, the commutator 700 simultaneously slides with the first guide surface 410 and the second guide surface 810 so that the actuation end 200 and the secondary driven member 400 can move in different directions.

Optionally, the first guide surface 410 and/or the second guide surface 810 are provided with lubrication layers respectively. The lubrication layers disposed on surfaces of the first guide surface 410 and the second guide surface 810 that are in slidable fit with the commutator 700 can reduce a friction force between the first guide surface 410 and the commutator 700 and a friction force between the second guide surface 810 and the commutator 700 so that a commutation process can be smoother, thereby ensuring a smoother actuation process of the piezoelectric actuator.

As an optional solution for the piezoelectric actuator, one end of the rail 800 is provided with a first avoidance notch 820 so that when the secondary driven member 400 moves facing the rail 800, one end of the secondary driven member 400 facing the rail 800 can be disposed in the first avoidance notch 820, effectively avoiding collision between the secondary driven member 400 and the rail 800.

Optionally, the first guide surface 410 is formed with a first avoidance groove 411 to reduce the contact area between the first guide surface 410 and the commutator 700, thereby reducing the friction force between the commutator 700 and the first guide surface 410.

Further, the first avoidance notch 820 is provided with a guide protrusion 830 that can be disposed within the first avoidance groove 411. The arrangement of the guide protrusion 830 that can fit with the first avoidance groove 411 can not only avoid interference between the rail 800 and the first guide surface 410 but also extend the slide length of the commutator 700 on the second guide surface 810, thereby increasing the actuation distance.

Optionally, the guide protrusion 830 is provided with a second avoidance notch 840. The arrangement of the second avoidance notch 840 can enable the groove bottom of the first avoidance groove 411 to be disposed within the second avoidance notch 840 when the secondary driven member 400 moves facing the rail 800, thereby effectively avoiding collision between the guide protrusion 830 and the first avoidance groove 411.

It is to be noted that in the solution of disposing the first commutation wheel 710 and the second commutation wheel 720, the arrangement of the first avoidance notch 820, the guide protrusion 830 and the second avoidance notch 840 can also avoid the first guide groove 420, reduce interference between the secondary driven member 400 and the rail 800 when the secondary driven member 400 moves and ensure a smoother and more reliable actuation process of the piezoelectric actuator.

In this embodiment, the second guide surface 810 is further formed with a second avoidance groove 812 to reduce the contact area between the second guide surface 810 and the commutator 700, thereby reducing the friction force between the commutator 700 and the second guide surface 810.

As an optional solution for the piezoelectric actuator, the commutator 700 includes the commutation shaft 730 and a commutation block 740 coaxially sleeved on the commutation shaft 730, the actuation end 200 is disposed on the commutation shaft 730, and the commutation block 740 is configured to be slidably connected to the first guide surface 410 and the second guide surface 810. The arrangement of the separated commutator 700 provides convenience for replacing the commutation block 740 after the commutation block 740 is worn, facilitating the prolonging of the service life of the piezoelectric actuator.

Optionally, the commutation block 740 is disposed as a hollow cylinder, the interior of the hollow cylinder is configured to be connected to the commutation shaft 730, and the exterior of the hollow cylinder is configured to be slidably connected to the first guide surface 410 and the second guide surface 810. It is to be understood that the outer wall of the hollow cylinder is in line contact with the first guide surface 410 and the second guide surface 810, which has a smaller friction force than the surface contact, thereby making the movement of the commutator 700 smoother.

Optionally, the outer wall of the commutation block 740 is provided with a lubrication layer. The outer wall of the commutation block 740 that fits with the first guide surface 410 and the second guide surface 810 is provided with the lubrication layer so that the friction force between the commutation block 740 and the first guide surface 410 and the friction force between the commutation block 740 and the second guide surface 810 can be reduced, making the commutation process smoother and thereby ensuring the smoother actuation process of the piezoelectric actuator.

What is claimed is:

1. A piezoelectric actuator, comprising:
a securing end, an actuation end and a piezoelectric assembly; and
a secondary driven member, a commutator and a rail, wherein the piezoelectric assembly is configured to drive the secondary driven member to move in a first direction relative to the securing end, the secondary driven member is provided with a first guide surface, the rail is provided with a second guide surface, the commutator comprises a commutation shaft, a first commutation wheel and a second commutation wheel, wherein the first commutation wheel and the second commutation wheel are coaxially sleeved on the commutation shaft, and the actuation end is disposed on the commutation shaft; the first commutation wheel is configured to roll along the first guide surface, and the second commutation wheel is configured to roll along the second guide surface, so that the commutator is movable in a second direction; and the second direction is set at an angle from the first direction.

2. The piezoelectric actuator of claim 1, wherein one end of the secondary driven member facing the commutator is formed with a first guide groove, a diameter of the first commutation wheel is less than a diameter of the second commutation wheel, a groove top of the first guide groove forms the first guide surface, and a groove depth of the first guide groove is greater than a difference between a radius of the first commutation wheel and a radius of the second commutation wheel.

3. The piezoelectric actuator of claim 2, wherein two first commutation wheels are provided, and the second commutation wheel is disposed between the two first commutation wheels.

4. The piezoelectric actuator of claim 2, wherein an axial length of each of the first commutation wheels is greater than an axial length of the second commutation wheel, and the second commutation wheel is rotatably disposed on an outer side of the first commutation wheel.

5. The piezoelectric actuator of claim 1, wherein one end of the secondary driven member facing the commutator is formed with a second guide groove, a diameter of the first commutation wheel is greater than a diameter of the second commutation wheel, a groove bottom of the second guide groove forms the first guide surface, and a groove depth of the second guide groove is less than a difference between a radius of the first commutation wheel and a radius of the second commutation wheel.

6. The piezoelectric actuator of claim 5, wherein two second commutation wheels are provided, and the first commutation wheel is disposed between the two second commutation wheels.

7. The piezoelectric actuator of claim 5, wherein the second guide surface is formed with a third guide groove extending in the second direction, and a groove depth of the third guide groove is greater than a difference between a radius of the first commutation wheel and a radius of the second commutation wheel.

8. The piezoelectric actuator of claim 1, wherein the first guide surface is disposed at an angle of 30° to 60° from the first direction.

9. The piezoelectric actuator of claim 1, wherein the securing end is provided with a guide rod extending in the first direction, and the secondary driven member is slidable along the guide rod.

10. The piezoelectric actuator of claim 9, wherein the secondary driven member is further formed with a guide groove extending in the first direction, and the guide rod is disposed within the guide groove.

11. The piezoelectric actuator of claim 1, wherein the actuation end is configured to be connected to an optical lens module or display module.

12. The piezoelectric actuator of claim 11, wherein the actuation end is configured to be connected to one of a plurality of installation lugs of an optical lens module or display module which is provided with the plurality of installation lugs in a circumferential direction of the optical lens module or display module.

13. The piezoelectric actuator of claim 2, wherein the securing end is provided with a guide rod extending in the first direction, and the secondary driven member is slidable along the guide rod.

14. The piezoelectric actuator of claim 3, wherein the securing end is provided with a guide rod extending in the first direction, and the secondary driven member is slidable along the guide rod.

15. The piezoelectric actuator of claim 4, wherein the securing end is provided with a guide rod extending in the first direction, and the secondary driven member is slidable along the guide rod.

16. The piezoelectric actuator of claim 5, wherein the securing end is provided with a guide rod extending in the first direction, and the secondary driven member is slidable along the guide rod.

17. The piezoelectric actuator of claim 6, wherein the securing end is provided with a guide rod extending in the first direction, and the secondary driven member is slidable along the guide rod.

18. The piezoelectric actuator of claim 7, wherein the securing end is provided with a guide rod extending in the first direction, and the secondary driven member is slidable along the guide rod.

19. The piezoelectric actuator of claim 2, wherein the actuation end is configured to be connected to an optical lens module or display module.

20. The piezoelectric actuator of claim 3, wherein the actuation end is configured to be connected to an optical lens module or display module.
